(19) United States
(12) Patent Application Publication
(10) Pub. No.: US 2026/0150026 A1
(43) Pub. Date: May 28, 2026

(54) METHOD, DEVICE AND COMPUTER STORAGE MEDIUM OF COMMUNICATION

(71) Applicant: NEC Corporation, Tokyo (JP)

(72) Inventors: Da WANG, Beijing (CN); Gang WANG, Beijing (CN)

(73) Assignee: NEC Corporation, Tokyo (JP)

(21) Appl. No.: 19/126,919

(22) PCT Filed: Nov. 3, 2022
(86) PCT No.: PCT/CN2022/129660

§ 371 Date: May 2, 2025

(51) Int. Cl. H04W 36/36; H04W 12/043; H04W 36/00; H04W 76/20

(52) U.S. Cl. CPC H04W 36/362; H04W 12/043; H04W 36/0038; H04W 76/20

(57) ABSTRACT

Embodiments of the present disclosure relate to methods, devices and computer readable media of communication. In one aspect, upon determination that a subsequent conditional cell change is to be performed from a source cell to a target cell, a terminal device performs a first set of procedures comprising at least one of the following: updating a security key associated with the target cell; performing PDCP re-establishment for a DRB and a SRB; or performing RLC re-establishment for the DRB and the SRB. In this way, UE behavior is clarified for support of selective activation of cell groups.

### TECHNICAL FIELD

Embodiments of the present disclosure generally relate to the field of telecommunication, and in particular, to methods, devices and computer storage media of communication for selective activation of cell groups.

### BACKGROUND

Currently, multi-random access technology dual connectivity (MR-DC) with selective activation of a cell group aims at enabling a subsequent conditional primary secondary cell (PSCell) change (CPC) after secondary cell group (SCG) change, without reconfiguration and re-initialization on a CPC/conditional PSCell addition (CPA) preparation from the network side. This results in a reduction of signaling overhead and an interrupting time for SCG change. However, a solution for a subsequent CPC/CPA after the CPC/CPA procedure is still incomplete and needs to be further developed.

### SUMMARY

In general, embodiments of the present disclosure provide methods, devices and computer storage media of communication for selective activation of cell groups.

In a first aspect, there is provided a method of communication. The method comprises: determining, at a terminal device, that a subsequent conditional cell change is to be performed from a source cell to a target cell; and performing a first set of procedures comprising at least one of the following: updating a security key associated with the target cell; performing packet data convergence protocol (PDCP) re-establishment for a data radio bearer (DRB) and a signaling radio bearer (SRB); or performing radio link control (RLC) re-establishment for the DRB and the SRB.

In a second aspect, there is provided a method of communication. The method comprises: receiving, at a first network device and from a terminal device, a message indicating that a conditional cell change is performed from a source cell to a target cell; and transmitting, to a second network device providing the source cell, an indication indicating release of a connection with the terminal device.

In a third aspect, there is provided a method of communication. The method comprises: determining, at a first network device, that a configuration for a subsequent conditional cell addition or change is to be released; and transmitting, to a second network device providing a candidate cell for the subsequent conditional cell addition or change, an indication indicating release of the configuration for the subsequent conditional cell addition or change.

In a fourth aspect, there is provided a device of communication. The device comprises a processor configured to cause the device to perform the method according to any of the first to third aspects of the present disclosure.

In a fifth aspect, there is provided a computer readable medium having instructions stored thereon. The instructions, when executed on at least one processor, cause the at least one processor to perform the method according to any of the first to third aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating network protocol layer entities that may be established for a user plane (UP) protocol stack at devices according to some embodiments of the present disclosure;

FIG. 1C illustrates a schematic diagram illustrating network protocol layer entities that may be established for a control plane (CP) protocol stack at devices according to some embodiments of the present disclosure;

FIG. 2 illustrates a schematic diagram illustrating an example process of communication according to embodiments of the present disclosure;

FIG. 3 illustrates a schematic diagram illustrating another example process of communication according to embodiments of the present disclosure;

FIG. 4 illustrates a schematic diagram illustrating still another example process of communication according to embodiments of the present disclosure;

FIG. 5 illustrates an example method of communication implemented at a terminal device in accordance with some embodiments of the present disclosure;

FIG. 6 illustrates an example method of communication implemented at a network device in accordance with some embodiments of the present disclosure;

FIG. 7 illustrates another example method of communication implemented at a network device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2(24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “selective activation of a cell group” may be interchangeably used with “a subsequent CPC/CPA” or “a subsequent conditional cell change or addition” or “a subsequent conditional handover” or “a selective activation of SCGs”, “a subsequent SCG change”, or “a subsequent cell group change or addition”. In the context of the present application, the term “a cell change or addition” may be interchangeably used with “reconfiguration WithSync for SCG or master cell group (MCG)”. In the context of the present application, the term “PSCell” refers to a SpCell of a SCG, the term “PCell” refers to a SpCell of a MCG, and the term “SpCell” refers to a primary cell of a SCG or MCG.

It has been agreed to specify mechanism and procedures of NR-DC with selective activation of cell groups (at least for SCG) via layer 3 (L3) enhancements. In particular, it has been agreed to allow subsequent cell group change after changing a cell group without reconfiguration and re-initiation of CPC/CPA. It has also been agreed that CPA selective activation of cell groups will be supported.

However, it is unclear how to determine layer 2 (L2) and security handling for subsequent CPC. Further, it is unclear how to release a configuration for selective activation of cell groups at a network side. In addition, it is unclear how to support subsequent CPA after SCG is released.

In view of this, embodiments of the present disclosure provide solutions for selective activation of a cell group. In one aspect, upon determination that a subsequent conditional cell change is to be performed from a source cell to a target cell, a terminal device performs a set of procedures comprising at least one of the following: updating a security key associated with the target cell; performing packet data convergence protocol (PDCP) re-establishment for a data radio bearer (DRB) and a signaling radio bearer (SRB); or performing radio link control (RLC) re-establishment for the DRB and the SRB. In this way, a UE behavior for selective activation of cell groups may be clarified.

In another aspect, upon reception of a message from a terminal device indicating a conditional cell change from a source cell to a target cell, a network device transmits, to another network device providing the source cell, an indication indicating release of a connection with the terminal device. In this way, a network behavior of releasing a connection with a terminal device for selective activation of cell groups may be clarified.

In still another aspect, upon determination that a configuration for a subsequent conditional cell change or addition is to be released, a network device transmits, to another network device providing a candidate cell for the subsequent conditional cell change or addition, an indication indicating release of the configuration for the subsequent conditional cell change or addition. In this way, a network behavior of releasing a configuration for selective activation of cell groups may be clarified.

It is to be understood that the present solutions may be applied in a SCG change, and also may be applied in a MCG change. For convenience, embodiments of the present disclosure will be described by taking a subsequent CPC as an example.

Principles and implementations of the present disclosure will be described in detail below with reference to the figures.

### Example of Communication Network

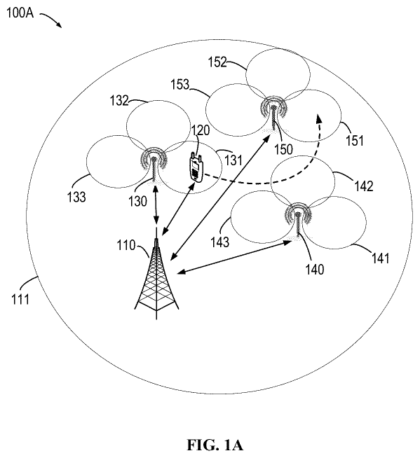

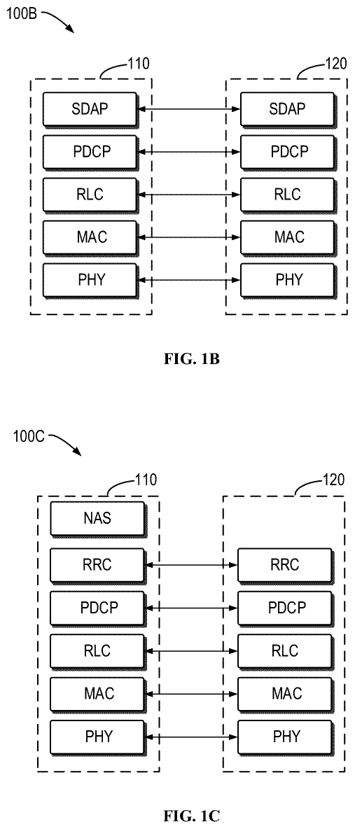

FIG. 1A illustrates a schematic diagram of an example communication network 100A in which embodiments of the present disclosure can be implemented. As shown in FIG. 1A, the communication network 100A may comprise a network device 110 and a terminal device 120. The network device 110 provides a cell 111 and the terminal device 120 is located in the cell 111 and served by the network device 110.

The communication network 100A may also comprise one or more other network devices such as network devices 130, 140 and 150. The network device 130 provides cells 131, 132 and 133. The network device 140 provides cells 141, 142 and 143, and the network device 150 provides cells 151, 152 and 153. It should be noted that the number of the cells are not limited to three, and more or less cells are also configured for the terminal device 110.

Assuming that the terminal device 120 may establish a dual connection (i.e., simultaneous connection) with two network devices. For example, the network device 110 may serve as a MN (for convenience, also referred to as MN 110 below), and the network device 130 may serve as a SN (for convenience, also referred to as SN 130 below). Although only the cell 111 is shown, the MN 110 may provide multiple cells, and these cells may form a MCG for the terminal device 120. Assuming that the cell 111 is a primary cell (i.e., PCell) in the MCG. Further, the cells 131, 132 and 133 provided by the network device 130 may form a SCG for the terminal device 120. Assuming that the cell 131 is a primary cell (i.e., PSCell) in the SCG.

The SN 130 may communicate with the terminal device 120 via a channel such as a wireless communication channel. Similarly, the MN 110 may also communicate with the terminal device 120 via a channel such as a wireless communication channel. The SN 130 may communicate with the MN 110 via a control-plane interface such as Xn-C. The MN 110 may communicate with the core network 160 such as the AMF 162 via a control-plane interface such as NG-C. The SN 130 may also communicate with the MN 110 via a user plane interface such as Xn-U, and communicate with the core network 160 such as the UPF 161 via a user plane interface such as NG-U.

It is to be understood that the number of devices or cells in FIG. 1A is given for the purpose of illustration without suggesting any limitations to the present disclosure. The communication network 100A may involve any suitable number of network devices and/or terminal devices and/or cells adapted for implementing implementations of the present disclosure.

The communications in the communication network 100A may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 120 towards the network device 110, 130, 140 or 150 is referred to as UL communication, while communication in a reverse direction from the network device 110, 130, 140 or 150 towards the terminal device 120 is referred to as DL communication. The terminal device 120 can move amongst the cells of the network devices 110, 130, 140 or 150 and possibly other network devices. In UL communication, the terminal device 120 may transmit UL data and control information to the network device 110, 130, 140 or 150 via a UL channel. In DL communication, the network device 110, 130, 140 or 150 may transmit DL data and control information to the terminal device 120 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure. For convenience, the following description is given by taking a communication between the terminal device 120 and the network device 110 as an example. It is to be understood that the following description is also suitable for the communication between the terminal device 120 and the network device 130, 140 or 150.

As shown in FIG. 1B, in the UP, each of the terminal device 120 and the network device 110 may comprise an entity for the L1 layer, i.e., an entity for a physical (PHY) layer (also referred to as a PHY entity), and one or more entities for upper layers (L2 and layer 3 (L3) layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 120 and the network device 110 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 120 may also comprise an entity for a non-access stratum (NAS) layer (also referred to as a NAS entity). An NAS layer at the network side is not located in a network device and is located in a core network (CN, not shown). In some cases, these entities are in a stack structure.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and a random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 120 may be configured with at least one DRB for bearing data plane data and at least one SRB for bearing control plane data.

In some embodiments, the network device 110 may configure, to the terminal device 120, a conditional reconfiguration for a set of candidate cells. The conditional reconfiguration may indicate that a subsequent CPC is enabled.

Assuming that the cells 131-133, 141-143 and 151-153 are configured to the terminal device 120 as candidate cells. In some scenarios, the terminal device 120 may initially communicate with only the network device 110. As the terminal device 120 moves, when a condition for a candidate cell (for example, the cell 131) is fulfilled, the terminal device 120 may be caused to establish the dual connection with the network device 110 and the network device 130. This process of SN addition may be called as a CPA.

In some scenarios, the terminal device 120 may establish a dual connection with the network devices 110 and 130. The network device 110 serves as a MN and the network device 130 serves as a SN. As the terminal device 120 moves, when a condition for another candidate cell (for example, the cell 142) is fulfilled, a SN serving the terminal device 120 may be changed from the network device 130 (also referred to as a source SN or current SN 130) to the network device 140 (also referred to as a target SN 140). This process of PSCell change may be called as a CPC. In some scenarios, after the terminal device is configured with conditional reconfiguration and with subsequent CPC being enabled, and before at least one execution condition is fulfilled for any candidate PSCell, the terminal device 120 may receive a RRC Reconfiguration message containing reconfiguration WithSync for SCG from the network device 110, and the terminal device 120 may perform a PSCell change or addition accordingly. This procedure is called as legacy PSCell change or addition. As an example, after the legacy PSCell change or addition procedure, the SN serving the terminal device 120 is the network device 140.

After the above CPA, CPC or legacy PSCell change/addition procedure, as the terminal device 120 further moves, when a condition for still another candidate cell (for example, the cell 152) is fulfilled, a SN serving the terminal device 120 may be changed from the network device 140 to the network device 150 (also referred to as a target SN 150). This process of SN change may be called as a subsequent CPC. As the terminal device 120 further moves, several more rounds of subsequent CPC may be performed.

As the terminal device 120 further moves, the terminal device 120 may move out of the coverage of the network device 130, 140 or 150. In this case, all SNs may be released. When the terminal device 120 enters in the coverage of the network device 130, 140 or 150 again, a SN addition may be performed. This process of SN addition may be called as subsequent CPA. As the terminal device 120 further moves, several more rounds of subsequent CPA may be performed.

Embodiments of the present disclosure provide solutions of communication for selective activation of cell groups such as subsequent CPC or subsequent CPA.

### Example Implementation of UE Behavior for Selective Activation of Cell Groups

Conventionally, whether UE performs PDCP re-establishment, PDCP recovery, PDCP SDU discard, RLC re-establishment and security key update are based on an explicit indication in a RRCReconfiguration message. However, for the case of subsequent CPC, a network is not able to predict the UE's moving trajectory, and thus unable to configure these behaviors properly in a RRCReconfiguration message.

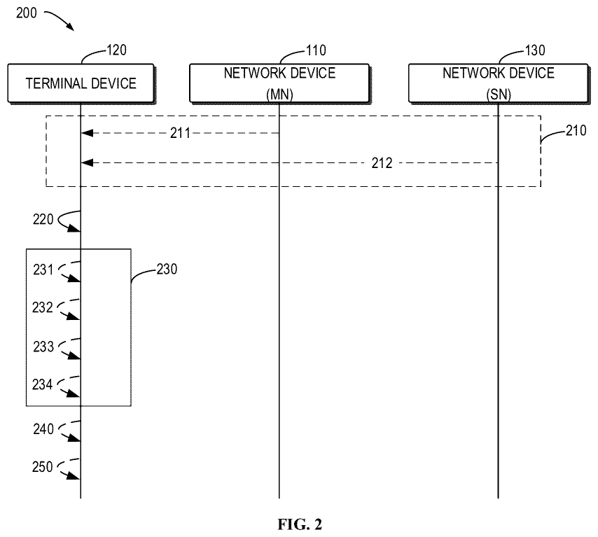

Embodiments of the present disclosure provide a solution for selective activation of cell groups to solve the above and other potential issues. For convenience, the solution will be described in connection with FIG. 2 below.

FIG. 2 illustrates a schematic diagram illustrating an example process 200 of communication according to embodiments of the present disclosure. For the purpose of discussion, the process 200 will be described with reference to FIG. 1A. The process 200 may involve the terminal device 120 and the network devices 110, 130 and 140 as illustrated in FIG. 1A. In this example, the network device 110 is a MN (for convenience, called as MN 110 hereinafter) serving the terminal device 120, the network device 140 is a potential target SN (for convenience, called as SN 140 hereinafter) serving the terminal device 120 and the cell 143 is a target PSCell. Assuming that the network device 130 is a source SN (for convenience, called as SN 130 hereinafter) serving the terminal device 120 and the terminal device 120 is served by the cell 131 (i.e., a source PSCell).

As shown in FIG. 2, the terminal device 120 may receive 210 a configuration (e.g., a conditional reconfiguration) for a selective activation of cell groups. In some embodiments, e.g., the terminal device 120 may receive 211 the conditional reconfiguration from the MN 110.

In some embodiments, the configuration for selective activation of cell group may indicate a set of configurations for a set of candidate cells (e.g., the cells 132, 133, 141, 142, 143, 151, 152 and 153) and a cell change condition associated with each candidate cell in the set of candidate cells. In some embodiments, the configuration for selective activation of cell groups may also include a cell addition condition associated with each candidate cell in the set of candidate cells. It is to be understood that the configuration may comprise any suitable information and the present disclosure does not limit this aspect.

The terminal device 120 may determine 220 that the subsequent conditional cell change is to be performed from a source PSCell (the cell 131) to a target PSCell (e.g., the cell 143). For example, the terminal device 120 may perform measurements on the set of candidate cells, and may determine that the cell 143 satisfies the cell change condition. Then the terminal device 120 may decide to perform a SN change to the cell 143 by applying the configuration associated with cell 143.

The terminal device 120 may perform 230 a set of procedures (for convenience, also referred to as a first set of procedures herein) for L2 and security handling during the subsequent conditional PSCell change.

In some embodiments, the first set of procedures may comprise updating a security key associated with the target PSCell (also referred to as secondary key). In some embodiments, the set of procedures may comprise performing PDCP re-establishment for a DRB and a SRB, e.g., for all DRBs and all SRBs. In some embodiments, the set of procedures may comprise performing RLC re-establishment for a DRB and a SRB, e.g., for all DRBs and all SRBs. That is, any of PDCP re-establishment and RLC re-establishment procedures may be triggered by a RRC layer of the terminal device 120 directly without any indication in a RRCReconfiguration message. It is to be understood that the first set of procedures may comprise any suitable combination of the above procedures.

With reference to FIG. 2, in some embodiments, if the subsequent conditional cell change is to be performed, the terminal device 120 may directly perform 231 the first set of procedures.

In some alternative embodiments, the terminal device 120 may determine 232 whether the source PSCell and the target PSCell are provided by different network devices.

In some embodiments, the terminal device 120 may determine information of a cell identity and a network device identity length of the source PSCell and the target PSCell, and determine, based on the information of the cell identity and the network device identity length of the source PSCell and the target PSCell, whether the source PSCell and the target PSCell are provided by different network devices.

For example, the terminal device 120 may obtain the information of the cell identity (e.g., cellIdentity) and the network device identity length (e.g., gNB-ID-Length) of the source PSCell (e.g., the cell 131) from system information (e.g., PLMN-IdentityInforList information element (IE)) of the SN 130 providing the source PSCell, and determine the information of the cell identity and the network device identity length of the target PSCell (e.g., the cell 143) via system information from the SN 140 providing the target PSCell.

The terminal device 120 may determine an identity (for convenience, also referred to as a first identity herein) of the SN 130 providing the source PSCell based on the information of the cell identity and the network device identity length of the source PSCell, and determine an identity (for convenience, also referred to as a second identity herein) of the SN 140 providing the target PSCell based on the information of the cell identity and the network device identity length of the target PSCell. If the first identity is different from the second identity, the terminal device 120 may determine that the source PSCell and the target PSCell are provided by different network devices. If the first identity is same as the second identity, the terminal device 120 may determine that the source PSCell and the target PSCell are provided by the same network device.

In some embodiments, the terminal device 120 may determine information associated with a set of candidate cells for the subsequent conditional cell change, and determine, based on the information associated with the set of candidate cells, whether the source PSCell and the target PSCell are provided by different network devices. In some embodiements, the information may be cell group or gNB or SN information associated with the candidate cells. For example, the terminal device 120 may obtain the information associated with a set of candidate cells from the configuration (e.g., conditional reconfiguration) for the selective activation of cell groups. In other words, the network device 110 may configures the information in or together with the conditional reconfiguration supporting selective activation of cell groups. Of course, any other suitable ways are also feasible.

In some embodiments, the information associated with the set of candidate cells may comprise at least one of the following: an identity of a cell group associated with a candidate cell in the set of candidate cells; an identity (e.g., gNB ID) of a network device associated with the candidate cell; or an identity of a SN associated with the candidate cell. It is to be understood that any other suitable information is also feasible. Such information may assist in determining whether to perform a set of L2 procedures and/or whether to update a security key associated with the target PSCell.

If the source PSCell and the target PSCell are associated with different cell groups or network devices, the terminal device 120 may determine that the source PSCell and the target PSCell are provided by different network devices. If the source PSCell and the target PSCell are associated with a same cell group or network device, the terminal device 120 may determine that the source PSCell and the target PSCell are provided by a same network device.

Continue to refer to FIG. 2, if the source PSCell and the target PSCell are provided by different network devices, the terminal device 120 may perform 233 the first set of procedures. If the source PSCell and the target PSCell are provided by the same network device, the terminal device 120 may perform 234 a second set of procedures.

In some embodiments, the second set of procedures may comprise performing PDCP recovery for a DRB, e.g., for all DRBs. In some embodiments, the second set of procedures may comprise performing PDCP service data unit (SDU) discard for a SRB, e.g., for all SRBs. In some embodiments, the second set of procedures may comprise performing a RLC re-establishment for a DRB and a SRB, e.g., for all DRBs and all SRBs. In some embodiments, the second set of procedures may comprise maintaining (i.e., not updating) a security key associated with the target PSCell. It is to be understood that the second set of procedures may comprise any suitable combination of the above procedures.

In some scenarios, SCG may be released. Conventionally, when SCG is released, UE may release a conditional reconfiguration for conditional cell change or addition. However, if a conditional reconfiguration supporting selective activation of cell groups is released, UE may be unable to perform subsequent CPA without new RRC Reconfiguration. In view of this, embodiments of the present disclosure also provide a solution for these scenarios.

Continue to refer to FIG. 2, the terminal device 120 may determine 240 that a SCG release is to be performed. Then the terminal device 120 may perform 250 a set of procedures (for convenience, also referred to as a third set of procedures herein).

In some embodiments, the third set of procedures may comprise maintaining stored information of a conditional reconfiguration. In some embodiments, the third set of procedures may comprise maintaining the stored information of the conditional reconfiguration supporting selective cell group activation. In some embodiments, maintain the stored information of conditional reconfiguration supporting selective cell group activation comprises at least one of the following: removing an entry within a configuration (e.g., SCG VarConditionlReconfig) for a SN-initiated conditional cell change; maintaining (i.e., not releasing) a stored configuration (e.g., MCG VarConditionlReconfig) for a MN-initiated conditional reconfiguration supporting selective activation of cell groups; or maintaining (i.e., not releasing) a stored configuration (e.g., MCG VarConditionlReconfig) for a MN-initiated conditional reconfiguration supporting subsequent conditional cell addition.

In some embodiments, the third set of procedures may comprise continuing performing a conditional reconfiguration evaluation for a subsequent conditional cell addition. In some embodiments, the third set of procedures may comprise suspending an conditional reconfiguration evaluation for the subsequent conditional cell change. It is to be understood that the third set of procedures may comprise any suitable combination of the above procedures. In this way, subsequent CPA after a SCG release may be supported.

When a PSCell cell change or addition is performed, a terminal device may initiate a random access (RA) procedure towards a target PSCell. Conventionally, upon completion of a RA procedure, a MAC entity of a terminal device may discard any explicitly signalled contention-free random access (CFRA) resources for 2-step RA type and 4-step RA type. However, this may result in that the CFRA resource is not useable for subsequent CPA and subsequent CPC.

In view of this, embodiments of the present disclosure provide a solution for selective activation of cell groups. In the solution, upon completion of a RA procedure for selective activation of cell group procedure, the terminal device 120 may maintain (i.e. does not discard) the corresponding 2-step RA and 4-step RA CFRA resources.

So far, UE behavior for selective activation of cell groups is clarified.

### Example Implementation of Network Behavior for Selective Activation of Cell Groups

Conventionally, a MN transmits, to a SN, a SN release request message to release UE context, i.e., both UE connection and conditional reconfiguration (as well as all other UE context) would be released. However, for the case of selective activation of cell groups, a SN may only need to release UE connection but maintain the conditional reconfiguration for selective activation of cell groups. Thus, it is unclear how to indicate release of the UE connection and release of the conditional reconfiguration separately.

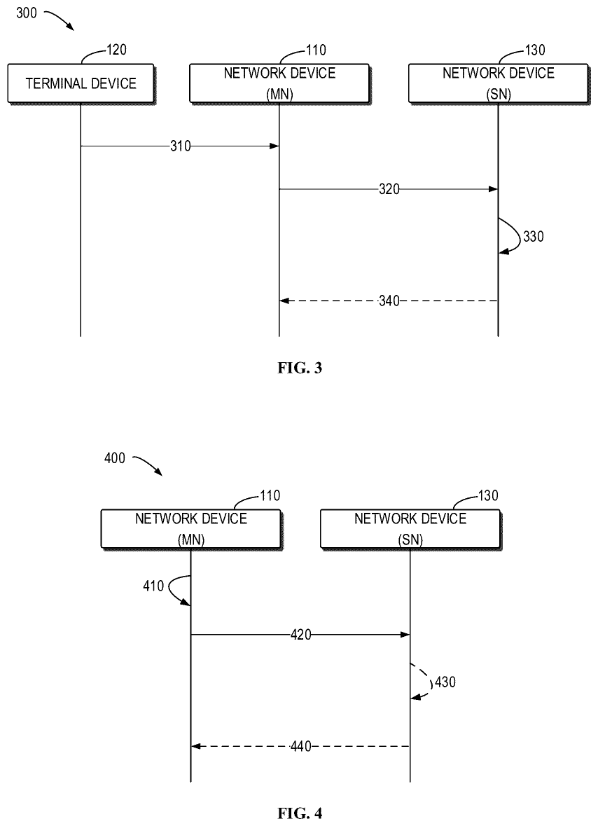

Embodiments of the present disclosure provide a solution for selective activation of cell groups to solve the above and other potential issues. For convenience, the solution will be described in connection with FIG. 3 below.

FIG. 3 illustrates a schematic diagram illustrating another example process 300 of communication according to embodiments of the present disclosure. For the purpose of discussion, the process 300 will be described with reference to FIG. 1A. The process 300 may involve the terminal device 120 and the network devices 110 and 130 as illustrated in FIG. 1A. In this example, the network device 110 is a MN (for convenience, called as MN 110 hereinafter) serving the terminal device 120, and the network device 130 is a source SN (for convenience, called as SN 130 hereinafter) serving the terminal device 120 and the terminal device 120 is in the cell 131 (i.e., a source PSCell).

As shown in FIG. 3, the terminal device 120 may transmit 310, to the MN 110, a message indicating that a conditional cell change is performed from a source PSCell (e.g., the cell 131) to a target PSCell (e.g., the cell 143). In some embodiments, the conditional cell change may be a subsequent conditional cell change. For example, when CPC is triggered, the terminal device 120 may transmit, to the MN 110, a RRCReconfigurationComplete message comprising a RRCReconfigurationComplete message for a selected candidate cell.

The MN 110 may transmit 320, to the SN 130 providing the source PSCell, an indication indicating release of a connection with the terminal device 120. Alternatively, the MN 110 may transmit, to the SN 130, an indication indicating cell group deactivation or suspend. Alternatively, the MN 110 may transmit, to the SN 130, an indication indicating leave of the terminal device 120.

In some embodiments, the MN 110 may transmit the indication via an Xn message. In some embodiments, the Xn message may be a newly defined message. In some embodiments, the Xn message may be an existing message such as a SN release request message. In some embodiments, the SN release request message may comprise an IE which indicates the release of a connection with the terminal device 120, cell group deactivation or suspend, or leave of the terminal device 120. It is to be understood that any other suitable ways are also feasible.

Continue to refer to FIG. 3, upon reception of the indication, the SN 130 may release 330 the connection with the terminal device 120 while maintaining the UE context (i.e. maintaining the conditional reconfiguration supporting selective cell group activation for the UE). The SN 130 may transmit 340, to the MN 110, an acknowledgement (ACK) for the release of the connection with the terminal device 120. Alternatively, the SN 130 may transmit an ACK for cell group deactivation or suspend. Alternatively, the SN 130 may transmit an ACK for leave of the terminal device 120.

In some embodiments, the ACK may be transmitted in an Xn message. In some embodiments, the Xn message may be a newly defined message. In some embodiments, the Xn message may be an existing message such as a SN release request acknowledge message. It is to be understood that any other suitable ways are also feasible.

In this way, release of a UE connection may be indicated separately from a release of a conditional reconfiguration.

FIG. 4 illustrates a schematic diagram illustrating still another example process 400 of communication according to embodiments of the present disclosure. For the purpose of discussion, the process 400 will be described with reference to FIG. 1A. The process 400 may involve the network device 110 and the network device 130, 140 or 150 as illustrated in FIG. 1A. In this example, the network device 110 is a MN (for convenience, called as MN 110 hereinafter) serving the terminal device 120, and the network device 130, 140 and 150 are SNs providing candidate cells. For convenience, only the network device 130 is shown as an example.

As shown in FIG. 4, the MN 110 may determine 410 that a conditional configuration for a subsequent conditional cell addition or change (i.e., selective activation of cell groups) is to be released. In some embodiments, a SN (e.g., the SN 130 or 140 or 150) may decide to release the configuration for the subsequent conditional cell addition or change and inform the MN 120 of the decision.

With reference to FIG. 4, the MN 110 may transmit 420, to the SN 130 or 140 or 150 providing a candidate cell for the subsequent conditional cell addition or change, an indication indicating release of the configuration for the subsequent conditional cell addition or change.

In some embodiments, the MN 110 may transmit the indication via an Xn message. In some embodiments, the Xn message may be a newly defined message. In some embodiments, the Xn message may be an existing message such as a SN release request message. In some embodiments, the SN release message may comprise an IE which indicates the cancel or release of the configuration for selective activation of cell groups. It is to be understood that any other suitable ways are also feasible.

Continue to refer to FIG. 4, the SN 130 or 140 or 150 may release 430 the configuration for the subsequent conditional cell addition or change. The SN 130 or 140 or 150 may transmit 440, to the MN 110, ACK for the release of the configuration for the subsequent conditional cell addition or change. In some embodiments, the ACK may be transmitted in an Xn message. In some embodiments, the Xn message may be a newly defined message. In some embodiments, the Xn message may be an existing message such as a SN release request acknowledge message. It is to be understood that any other suitable ways are also feasible.

In this way, release of a conditional reconfiguration may be indicated separately from release of a UE connection.

It is to be understood that operations in the processes 200, 300 and 400 may be carried out separately or in any suitable combination.

### Example Implementation of Methods

Accordingly, embodiments of the present disclosure provide methods of communication implemented at a terminal device and a network device. These methods will be described below with reference to FIGS. 5 to 7.

FIG. 5 illustrates an example method 500 of communication implemented at a terminal device in accordance with some embodiments of the present disclosure. For example, the method 500 may be performed at the terminal device 120 as shown in FIG. 1A. For the purpose of discussion, in the following, the method 500 will be described with reference to FIG. 1A. It is to be understood that the method 500 may include additional blocks not shown and/or may omit some blocks as shown, and the scope of the present disclosure is not limited in this regard.

At block 510, the terminal device 120 determines that a subsequent conditional cell change is to be performed from a source cell to a target cell.

At block 520, the terminal device 120 performs a first set of procedures during the subsequent conditional cell change. The first set of procedures comprises at least one of the following: updating a security key associated with the target cell; performing PDCP re-establishment for a DRB and a SRB; or performing RLC re-establishment for the DRB and the SRB.

In some embodiments, the terminal device 120 may determine information of a cell identity and a network device identity length of the source cell and the target cell, and determine, based on the information of the cell identity and the network device identity length of the source cell and the target cell, whether the source cell and the target cell are provided by different network devices.

In some embodiments, the terminal device 120 may determine a first identity of a network device providing the source cell based on the information of the cell identity and the network device identity length of the source cell, and determine a second identity of a network device providing the target cell based on the information of the cell identity and the network device identity length of the target cell. If the first identity is same as the second identity, the terminal device 120 may determine that the source cell and the target cell are provided by the same network device. If the first identity is different from the second identity, the terminal device 120 may determine that the source cell and the target cell are provided by different network devices.

In some embodiments, the terminal device 120 may determine information associated with a set of candidate cells for the subsequent conditional cell change, and determine, based on the information associated with the set of candidate cells, whether the source cell and the target cell are provided by different network devices. In some embodiments, the information associated with the set of candidate cells may comprise at least one of the following: an identity of a cell group associated with a candidate cell in the set of candidate cells; an identity of a network device associated with the candidate cell; or an identity of a secondary node associated with the candidate cell.

In some embodiments, if the source cell and the target cell are provided by different network devices, the terminal device 120 may perform the first set of procedures. In some embodiments, the terminal device 120 may determine, based on the information of the cell identity and the network device identity length of the source cell and the target cell, that the source cell and the target cell are provided by a same network device. In these embodiments, the terminal device 120 may perform a second set of procedures comprising at least one of the following: performing PDCP recovery for the DRB; performing PDCP service data unit, SDU, discard for the SRB; performing the RLC re-establishment for the DRB and the SRB; or maintaining the security key associated with the target cell.

In some embodiments, the terminal device 120 may determine that a SCG release is to be performed. In these embodiments, the terminal device 120 may perform a third set of procedures comprising at least one of the following: maintaining stored information of a conditional reconfiguration; continuing performing an evaluation for a subsequent conditional cell addition; or suspending an evaluation for the subsequent conditional cell change.

In some embodiments, the terminal device 120 may maintain the stored information of the conditional reconfiguration by at least one of the following: removing an entry within a configuration for a SN-initiated subsequent conditional cell change; maintaining a stored configuration for a MN-initiated subsequent conditional cell change; or maintaining a stored configuration for a MN-initiated subsequent conditional cell addition.

In some embodiments, the terminal device 120 may perform a RA procedure for a subsequent conditional cell change or addition. Upon completion of the RA procedure, the terminal device 120 may maintain CFRA resources.

With the method 500, UE behavior may be clarified for well supporting selective activation of cell groups.

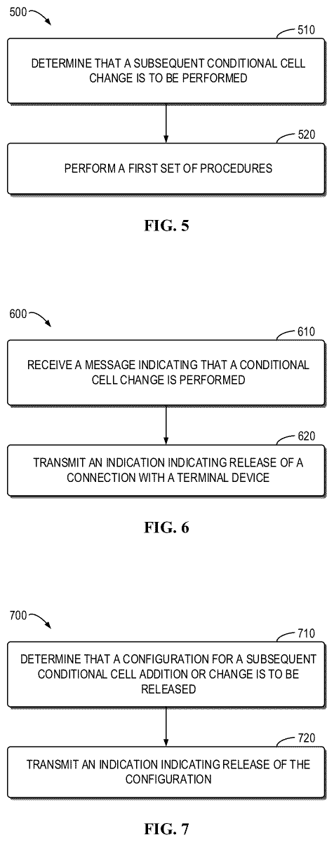

FIG. 6 illustrates an example method 600 of communication implemented at a network device in accordance with some embodiments of the present disclosure. For example, the method 600 may be performed at the network device 110 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard.

At block 610, a first network device (e.g., the network device 110) receives, from a terminal device (e.g., the terminal device 120), a message indicating that a conditional cell change is performed from a source cell (e.g., the cell 131) to a target cell (e.g., the cell 143).

At block 620, the network device 110 transmits, to a second network device (e.g., the network device 130) providing the source cell, an indication indicating release of a connection with the terminal device 120. In this way, the second network device may release the connection with the terminal device 120 and maintain a configuration for selective activation of cell groups. It is to be understood that the indication may be transmitted in any suitable ways.

In some embodiments, the network device 110 may receive, from the network device 130, an ACK for the release of the connection with the terminal device 120. It is to be understood that the ACK may be transmitted in any suitable ways.

With the method 600, a network behavior may be clarified for well supporting subsequent CPC.

FIG. 7 illustrates another example method 700 of communication implemented at a network device in accordance with some embodiments of the present disclosure. For example, the method 700 may be performed at the network device 110 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard.

At block 710, a first network device (e.g., the network device 110) determines that a configuration for a subsequent conditional cell addition or change is to be released.

At block 720, the network device 110 transmits, to a second network device (e.g., the network device 130, 140 or 150) providing a candidate cell for the subsequent conditional cell addition or change, an indication indicating release of the configuration for the subsequent conditional cell addition or change. It is to be understood that the indication may be transmitted in any suitable ways.

In some embodiments, the network device 110 may receive, from the second network device (e.g., the network device 130, 140 or 150), an ACK for the release of the configuration for the subsequent conditional cell addition or change. It is to be understood that the ACK may be transmitted in any suitable ways.

With the method 700, a network behavior may be clarified for well supporting subsequent CPA.

It is to be understood that the operations of methods 500, 600 and 700 are similar as that described in connection with FIGS. 2 to 4, and thus other details are not repeated here for concise.

### Example Implementation of Devices and Apparatuses

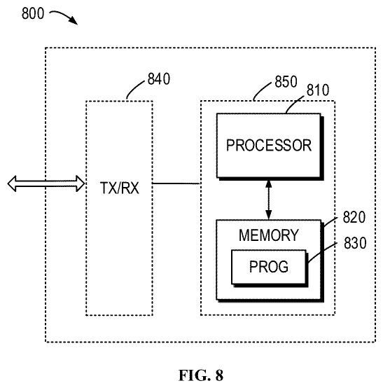

FIG. 8 is a simplified block diagram of a device 800 that is suitable for implementing embodiments of the present disclosure. The device 800 can be considered as a further example implementation of the terminal device 120 or the network device 110, 130 or 140 as shown in FIG. 1A. Accordingly, the device 800 can be implemented at or as at least a part of the terminal device 120 or the network device 110, 130 or 140.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 2 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises a circuitry configured to: determine that a subsequent conditional cell change is to be performed from a source cell to a target cell; and perform a first set of procedures comprising at least one of the following: updating a security key associated with the target cell; performing PDCP re-establishment for a DRB and a SRB; or perform RLC re-establishment for the DRB and the SRB.

In some embodiments, a first network device comprises a circuitry configured to: receive, from a terminal device, a message indicating that a conditional cell change is performed from a source cell to a target cell; and transmit, to a second network device providing the source cell, an indication indicating release of a connection with the terminal device.

In some embodiments, a first network device comprises a circuitry configured to: determine that a configuration for a subsequent conditional cell addition or change is to be released; and transmit, to a second network device providing a candidate cell for the subsequent conditional cell addition or change, an indication indicating release of the configuration for the subsequent conditional cell addition or change.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-15. (canceled)

16. A method of a User Equipment (UE), the method comprising:
receiving, from a network, a conditional reconfiguration for a subsequent conditional PSCell addition or change, wherein the conditional reconfiguration indicates that a configuration of one or more candidate PSCells for the subsequent conditional PSCell addition or change is supported; and
receiving, from the network, information which is used to determine whether the UE should perform a security update when the conditional reconfiguration is executed, wherein the information identifies a first cell set related to the one or more candidate PSCells.

17. The method according to claim 16, further comprising:
performing the subsequent conditional PSCell addition or change.

18. The method according to claim 16, further comprising:
performing, in a case where the first cell set is different from a second cell set related to a serving PSCell, the security update which includes a security key update related to a secondary key.

19. The method according to claim 16, further comprising:
performing, in a case where the first cell set is different from a second cell set related to a serving PSCell, a Packet Data Convergence Protocol (PDCP) re-establishment for a Data Radio Bearer (DRB) and a Signalling Radio Bearer (SRB).

20. The method according to claim 16, further comprising:
performing, in a case where the first cell set is different from a second cell set related to a serving PSCell, a Radio Link Control (RLC) re-establishment for a Data Radio Bearer (DRB) and a Signalling Radio Bearer (SRB).

21. The method according to claim 16, further comprising:
performing, in a case where the first cell set is same as a second cell set related to a serving PSCell, a Packet Data Convergence Protocol (PDCP) recovery for a Data Radio Bearer (DRB).

22. The method according to claim 16, further comprising:
performing, in a case where the first cell set is same as a second cell set related to a serving PSCell, a Packet Data Convergence Protocol (PDCP) Service Data Unit (SDU) discard for a Signalling Radio Bearer (SRB).

23. The method according to claim 16, further comprising:
performing a Secondary Cell Group (SCG) release;
maintaining the conditional reconfiguration associated with a Master Cell Group (MCG); and
evaluating execution conditions of the one or more candidate PSCells.

24. The method according to claim 23,
wherein the UE is configured to receive the conditional reconfiguration from a Master Node (MN).

25. The method according to claim 16, further comprising:
sending, to a Master Node (MN), a Radio Resource Control (RRC) Reconfiguration Complete message which includes an RRC Reconfiguration Complete message for a selected candidate PScell.

26. The method according to claim 25,
wherein the MN is configured to inform, to a Secondary Node (SN), that the UE has been moved to another SN.

27. A method of a network device, the method comprising:
sending, to a User Equipment (UE), a conditional reconfiguration for a subsequent conditional PSCell addition or change, wherein the conditional reconfiguration indicates that a configuration of one or more candidate PSCells for the subsequent conditional PSCell addition or change is supported; and
sending, to the UE, information which is used to determine whether the UE should perform a security update when the conditional reconfiguration is executed, wherein the information identifies a first cell set related to the one or more candidate PSCells.

28. A User Equipment (UE) comprising:
a memory; and
a processor coupled with the memory, wherein the processor is configured to:
receive, from a network, a conditional reconfiguration for a subsequent conditional PSCell addition or change, wherein the conditional reconfiguration indicates that a configuration of one or more candidate PSCells for the subsequent conditional PSCell addition or change is supported, and
receive, from the network, information which is used to determine whether the UE should perform a security update when the conditional reconfiguration is executed, wherein the information identifies a first cell set related to the one or more candidate PSCells.

29. A network device comprising:
a memory; and
a processor coupled with the memory, wherein the processor is configured to:
send, to a User Equipment (UE), a conditional reconfiguration for a subsequent conditional PSCell addition or change, wherein the conditional reconfiguration indicates that a configuration of one or more candidate PSCells for the subsequent conditional PSCell addition or change is supported, and
send, to the UE, information which is used to determine whether the UE should perform a security update when the conditional reconfiguration is executed, wherein the information identifies a first cell set related to the one or more candidate PSCells.
